(19) United States
(12) Patent Application Publication
(10) Pub. No.: US 2007/0080898 A1
(43) Pub. Date: Apr. 12, 2007

(54) Plasma display and driving method thereof

(76) Inventor: Du-Yeon Han, Suwon-si (KR)

Correspondence Address: Robert E. Bushnell, Suite 300, 1522 K Street, N.W., Washington, DC, 20005, US

(21) Appl. No.: 11/527,587

(22) Filed: Sep. 27, 2006

(30) Foreign Application Priority Data
Oct. 6, 2005 (KR) 10-2005-0093815

(51) Int. Cl. G09G 3/28

(52) U.S. Cl. 345/63

(57) ABSTRACT

In a plasma display device, X and Y electrodes are divided into a first group disposed in even-numbered rows and a second group disposed in odd-numbered rows, and the respective groups are again divided into a plurality of sub-groups. In addition, at respective subfields of one field, address periods are performed for the first and second groups, and sustain periods are performed between the address periods of the respective sub-groups. In addition, address periods are performed for the second group while sustain periods are performed for the first group, and sustain periods are performed for the first group while address periods are performed for the second group. As such, since priming particles formed during the sustain period are sufficiently used during the address period in that the address periods are disposed between the sustain periods of the respective sub-groups, the width of the scan pulse becomes shorter so as to increase the speed of the scan, and the sustain period is operated during the address period to reduce the length of the subfield.

### CLAIM OF PRIORITY

This application makes reference to, incorporates the same herein, and claims all benefits accruing under 35 U.S.C. §119 from an application for PLASMA DISPLAY AND DRIVING METHOD THEREOF earlier filed in the Korean Intellectual Property Office on the 6 Oct. 2005 and there duly assigned Ser. No. 10-2005-0093815.

### BACKGROUND OF THE INVENTION

1. Technical Field

The present invention relates to a plasma display device and a driving method thereof.

2. Related Art

A plasma display device uses a plasma display panel (PDP) which uses plasma generated by gas discharge to display characters or images. The PDP includes a plurality of discharge cells arranged in a matrix pattern.

In a general plasma display device, a field (1 TV field) is divided into a plurality of subfields respective weights, and gray scales are expressed by a summation of weights of subfields at which a display operation is generated from among the subfields. Each subfield has an address period in which an address operation for selecting discharge cells to emit light and discharge cells to emit no light from among a plurality of discharge cells occurs, and a sustain period in which a sustain discharge occurs in the selected discharge cells to perform a display operation during a period corresponding to a weight of a subfield.

Such a plasma display device uses subfields having different weight values for expression of grayscales. In addition, a grayscale of a corresponding discharge cell is expressed by a total of the weight values of subfields in which the discharge cell emits light at the plurality of subfields of the discharge cell. When the subfields with weights in the format of a power of 2 are used, contour noise can occur when a discharge cell expresses the grayscales of 127 and 128 in two consecutive frames.

In addition, when address and sustain periods are temporally separated, the length of one subfield becomes longer because the respective subfields have additionally formed address periods for addressing all of the discharge cells other than the sustain period for a sustain discharge. As a result, the number of subfields available in one field is reduced since the subfield has a longer length.

The above information disclosed in this section is provided only to enhance an understanding of the background of the invention, and therefore it may contain information that does not form the prior art that is already known to a person of ordinary skill in the art in this country.

### SUMMARY OF THE INVENTION

The present invention has been developed in an effort to provide a plasma display device and a driving method thereof having the advantages of reducing false contour and the length of a subfield.

An exemplary embodiment of the present invention provides a method for driving a plasma display device having a plurality of row electrodes and a plurality of column electrodes, and a plurality of discharge cells defined by the plurality of row and column electrodes, and one field is divided into a plurality of subfields. The driving method comprises the steps of: dividing the plurality of row electrodes into a first row group disposed in even-numbered rows and a second row group disposed in odd-numbered rows; dividing the first row group of row electrodes into a plurality of first sub-groups and dividing the second row group of row electrodes into a plurality of second sub-groups; at respective first subfields of a first group of subfields among the plurality of subfields, selecting non-light emitting cells among light emitting cells of one first sub-group among the plurality of first sub-groups and sustain-discharging light emitting cells of at least one of the plurality of second sub-groups during a first period respectively corresponding to at least one second sub-group; and at the respective first subfields, selecting the non-light emitting cells among the light emitting cells of one of the plurality of second sub-groups and sustain-discharging the light emitting cells of at least one of the plurality of first sub-groups during a second period respectively corresponding to the at least one first sub-group.

Another exemplary embodiment of the present invention provides a plasma display device comprising: a plasma display panel (PDP) having a plurality of row electrodes for performing a display operation and a plurality of column electrodes formed in a direction crossing the row electrodes, and a plurality of cells formed at crossing parts of the plurality of row electrodes and the plurality of column electrodes; a controller for dividing one field into a plurality of subfields, for dividing the plurality of row electrodes into a first row group disposed in odd-numbered rows and a second row group disposed in even-numbered rows, for dividing the first row group of row electrodes into a plurality of first sub-groups, and for dividing the second row group of row electrodes into a plurality of second sub-groups; and a driver for driving the plurality of row electrodes and the plurality of column electrodes. At this point, the driver at respective consecutive pluralities of first subfields among the plurality of subfields selects non-light emitting cells among light emitting cells of the respective first sub-groups during a first period of the respective first sub-groups, sustain-discharges the light emitting cells of the plurality of second sub-groups, selects non-light emitting cells among light emitting cells of the respective second sub-groups during a third period of the respective second sub-groups, and sustain-discharges the light emitting cells of the plurality of first sub-groups, wherein the third period is provided between adjacent first periods.

Yet another exemplary embodiment of the present invention provides a method for driving a plasma display device having a plurality of first and second row electrodes and a plurality of column electrodes, and a plurality of discharge cells defined by the plurality of first and second row and column electrodes, one field being divided into a plurality of subfields. The driving method comprises the steps of: dividing the respective pluralities of first and second row electrodes into a first row group disposed in odd-numbered rows and a second row group disposed in even-numbered rows; dividing the first row group of first row electrodes into a plurality of first sub-groups; dividing the second row group of first row electrodes into a plurality of second sub-groups; at one or more first subfields among the plurality of subfields, selecting light emitting cells among discharge cells of the first row group and sustain discharging the selected light emitting cells of the first row group; at the first subfield, selecting light emitting cells among discharge cells of the second row group and sustain-discharging the selected light emitting cells of the second row group; at each of the plurality of second subfields among the plurality of subfields, selecting non-light emitting cells among light emitting cells of one of the plurality of first sub-groups and sustain-discharging light emitting cells of at least one of the plurality of second sub-groups during a first period respectively corresponding to at least one second sub-group; and at the respective second subfields, selecting the non-light emitting cells among the light emitting cells of the one of the plurality of second sub-groups and sustain-discharging the light emitting cells of at least one of the plurality of first sub-groups during a second period respectively corresponding to the at least one first sub-group.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic diagram of a plasma display device according to an embodiment of the present invention.

FIG. 2 shows a method for grouping the respective electrodes used in a driving method of a plasma display device according to an exemplary embodiment of the present invention.

FIG. 3 shows a driving method of a plasma display device according to a first exemplary embodiment of the present invention.

FIG. 4 shows the driving method of FIG. 3 using only a subfield.

FIG. 5 shows a driving waveform of a plasma display device according to a driving method of FIG.3.

FIG. 6 shows a method for expressing a grayscale using the driving method of FIG. 3 according to a first exemplary embodiment of the present invention.

FIG. 7 shows a method for expressing a grayscale using the driving method of FIG. 3 according to a second exemplary embodiment of the present invention.

FIG. 8A and FIG. 8B respectively show a method for realizing a weight value of subfields SF1 to SF6.

FIG. 9 schematically shows a driving method of a plasma display device according to a second exemplary embodiment of the present invention.

FIG. 10 schematically shows a driving method of a plasma display device according to a third exemplary embodiment of the present invention.

### DETAILED DESCRIPTION OF THE INVENTION

In the following detailed description, only preferred embodiments of the invention have been shown and described, simply by way of illustration of the best modes contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals. In addition, throughout this specification and the claims which follow, unless explicitly described to the contrary, the word “comprise” or variations such as “comprises” or “comprising” will be understood to imply the inclusion of stated elements but not the exclusion of any other elements.

In addition, wall charges mentioned in the following description mean charges formed and accumulated on a wall (e.g., a dielectric layer) close to an electrode of a discharge cell. A wall charge will be described as being “formed” or “accumulated” on the electrode, although the wall charges do not actually touch the electrodes. Furthermore, a wall voltage means a potential difference formed on the wall of the discharge cell by the wall charge.

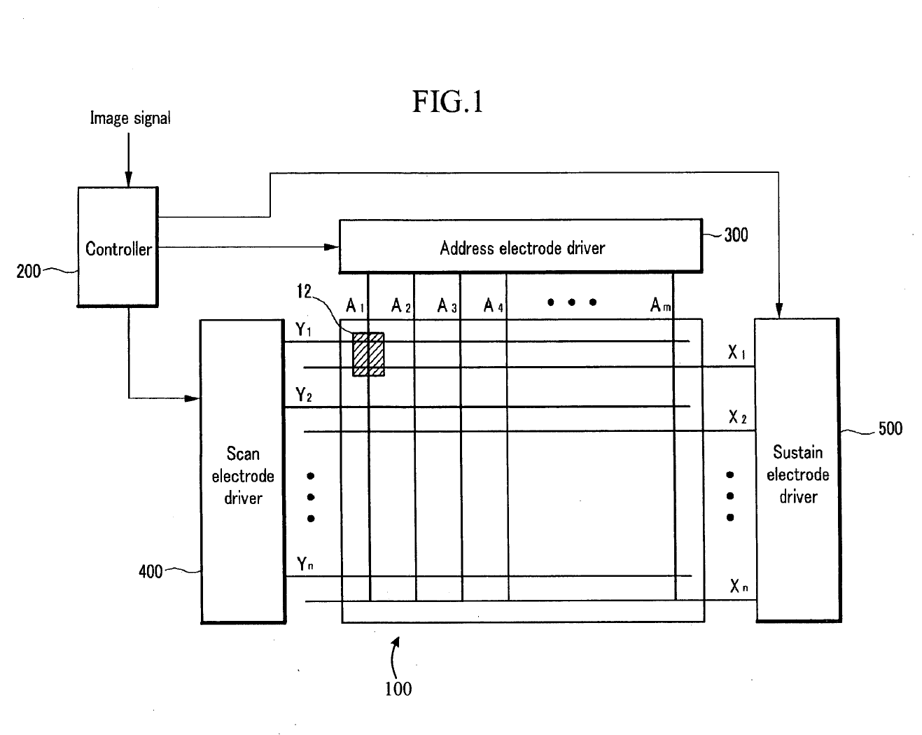

A plasma display device according to an exemplary embodiment of the present invention will now be described with reference to FIG. 1, which is a schematic diagram of a plasma display device according to an embodiment of the present invention.

As shown in FIG. 1, the plasma display device according to the exemplary embodiment of the present invention includes a plasma display device (PDP) 100, a controller 200, an address electrode driver 300, a scan electrode driver 400, and a sustain electrode driver 500.

The PDP 100 includes a plurality of address electrodes A₁ to Aₘ (hereinafter referred to as “A electrodes”) extending in a column direction, and a plurality of sustain electrodes X₁ to Xₙ and scan electrodes Y₁ to Yₙ (hereinafter respectively referred to as “X electrodes” and “Y electrodes”) extending in a row direction by pairs. The X electrodes X₁ to Xₙ are formed in correspondence to the Y electrodes Y₁ to Yₙ, and a display operation is performed by the X and Y electrodes in the sustain period. The Y electrodes Y₁ to Yₙ and X electrodes X₁ to Xₙ are arranged perpendicular to the A electrodes A₁ to Aₘ. In this regard, a discharge space formed at an area where the A electrodes A₁ to Aₘ cross the X and Y electrodes X₁ to Xₙ and Y₁ to Yₙ, respectively, forms a discharge cell 12. The configuration of the PDP 100 shown in FIG. 1 is an example, and another exemplary configuration may be applied in the present invention. Hereinafter, the X and Y electrodes extending by pairs in a row direction are referred to as row electrodes, and the A electrodes extending in a column direction are referred to as column electrodes.

The controller 200 outputs X, Y, and A electrode driving control signals after externally receiving an image signal. In addition, the controller 200 drives the plasma display device by dividing a frame into a plurality of subfields, and controls the plasma display device by dividing the plurality of row electrodes into first and second row groups and by dividing the row electrodes of the first and second row groups into a plurality of respective sub-groups.

The address electrode driver 300 receives the address electrode driving control signal from the controller 200, and applies a display data signal for selecting a discharge cell to be discharged to each address electrode A.

The scan electrode driver 400 receives the scan electrode driving control signal from the controller 200, and applies the driving voltage to the scan electrode Y.

The sustain electrode driver 500 receives the sustain electrode driving control signal from the controller 200, and applies the driving voltage to the sustain electrode X.

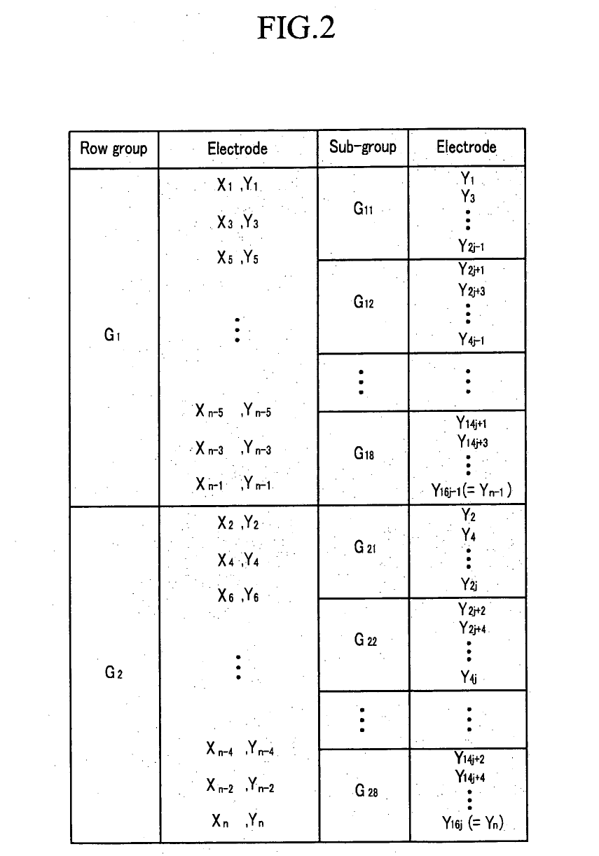

A driving method of the plasma display device according to the exemplary embodiment of the present invention will now be described in more detail with reference to FIG. 2 which shows a method for grouping the respective electrodes used in a driving method of a plasma display device according to an exemplary embodiment of the present invention.

As shown in FIG. 2, at one field, the plurality of row electrodes X₁ to Xₙ and Y₁ to Yₙ are divided into two row groups, that is, first and second row groups G₁ and G₂, respectively. In this regard, the first row group G₁ includes a plurality of X electrodes X₁, X₃, . . . , Xₙ₋₁ and a plurality of Y electrode Y₁, Y₃, . . . , Yₙ₋₁ placed in odd-numbered rows, and the second row group G₂ includes a plurality of X electrodes X₂, X₄, . . . , Xₙ and a plurality of Y electrodes Y₂, Y₄, . . . , Yₙ placed in even-numbered rows. In addition, the plurality of Y electrodes of the first and second row groups G₁ and G₂, respectively, are again divided into a plurality of sub-groups G₁₁, to G₁₈ and G₂₁ to G₂₈, respectively. In FIG. 2, it is assumed that the first and the second row groups G₁ and G₂, respectively, are divided into eight sub-groups G to G₁₈ and G₂₁ to G₂₈, respectively.

In addition, in the first row group G₁, first to (2j−1)-th Y electrodes Y₁, Y₃, . . . , Y₂ⱼ₋₁ are grouped into a first sub-group G, and (2j+1)-th to (4j−1)-th Y electrodes Y₂ⱼ₊₁, Y₂ⱼ₊₃, . . . , Y₄ⱼ₋₁ are grouped into a second sub-group G₁₂. In such a manner, (14j+1)-th to (n−1)-th(=(16j−1)-th) Y electrodes Y₁₄ⱼ₊₁, Y₁₄ⱼ₊₃, . . . , Y₁₆ⱼ₋₁, are grouped into an eighth sub-group G8 (here, j is given as an integer between 1 and n/16). Likewise, in the second row group G₂, second to 2j-th Y electrodes Y₂, Y₄, . . . , Y₂ⱼ are grouped into a first sub-group G₂₁, and (2j+2)-th to 4j-th Y electrodes Y₂ⱼ₊₂, Y₂ⱼ₊₄, . . . , Y₄ⱼ are grouped into a second sub-group G₂₂. In such a manner, (14j+2)-th to n-th(=16j-th) Y electrodesy Y₁₄ⱼ₊₂, Y₄ⱼ₊₄, . . . , Y₁₆ⱼ are grouped into an eighth sub-group G₂₈. Meanwhile, the Y electrodes spaced apart by a predetermined interval in the first and second row groups G₁ and G₂ may be grouped into one sub-group, and if necessary, the Y electrodes may be grouped in an irregular manner.

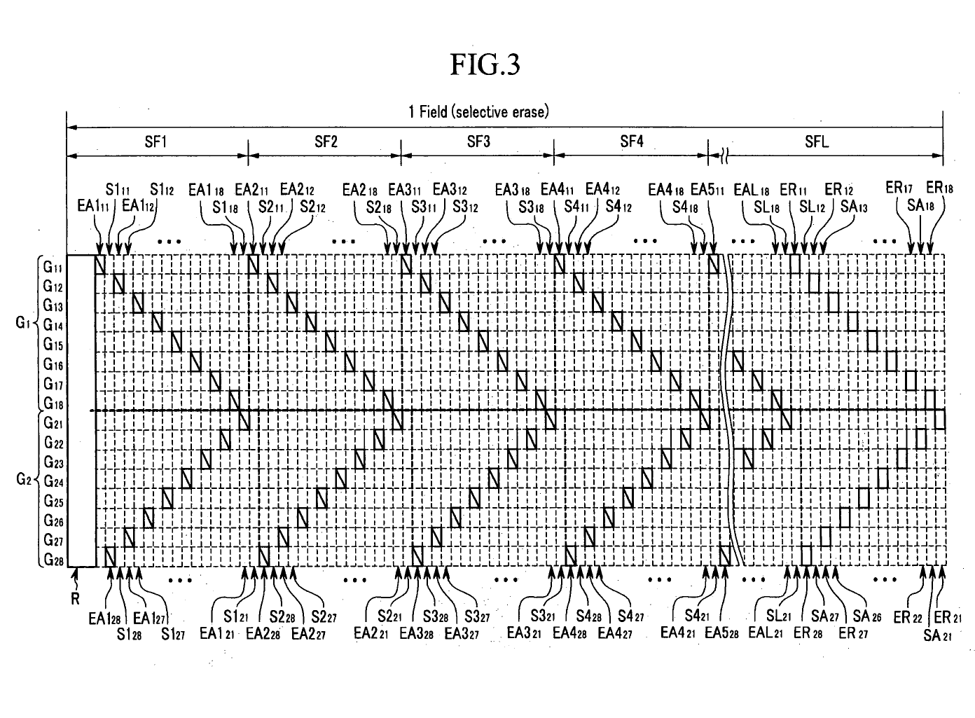

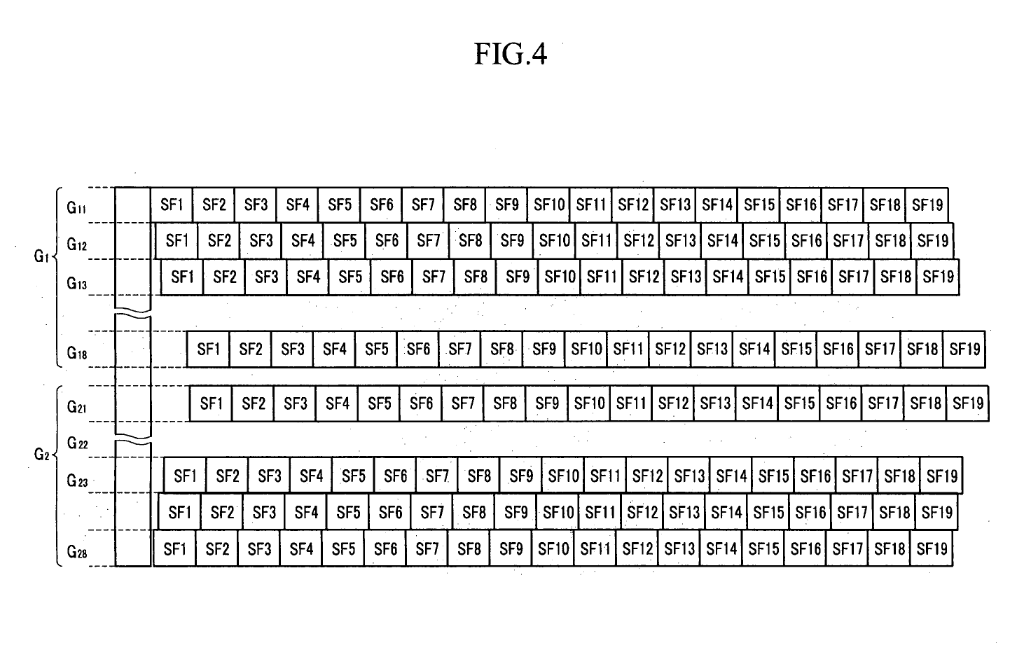

FIG. 3 shows a driving method of a plasma display device according to a first embodiment of the present invention, and FIG. 4 shows the driving method of FIG. 3 using only a subfield. According to a first exemplary embodiment of the present invention, the address and sustain periods have the same length, and the sustain period has the same length over all of the subfields.

Referring to FIG. 3, one field includes a plurality of subfields SF1 to SFL. At this point, first to L-th subfields SF1 to SFL, respectively, include address periods EA1₁₁ to EAL₁₈ and EA1₂₁ to EAL₂₈, respectively, and sustain periods S1₁₁ to SL₁₈ and S1₂₁ to SL₂₈, respectively, and the address periods EA11 to EAL8 of the first and L-th subfields SF1 to SFL, respectively, are achieved in a selective erase method. In addition, as shown in FIG. 2, the plurality of row electrodes X₁ to Xₙ and Y₁ to Yₙ are divided into the first and second row groups G₁ and G₂, respectively, and the first and second row groups G₁ and G₂, respectively, are divided into the plurality of sub-groups G₁₁ to G₁₈ and G₂₁ to G₂₈, respectively.

There are a selective write method and a selective erase method used to select discharge cells to emit light and those to emit no light among the plurality of discharge cells. The selective write method selects discharge cells to emit light and forms a constant wall voltage. The selective erase method selects discharge cells to emit no light and erases the formed wall voltage. That is, the selective write method sets a discharge cell to a light-emitting cell state by address-discharging the same so as to form wall charges therein, and the selective erase method sets the light-emitting discharge cell to a non-light emitting cell state by address-discharging the same so as to erase the wall voltage formed therein. According to these methods, an address discharge for forming the wall voltage will be referred to as a “write discharge” and an address discharge for erasing the wall charge will be referred to as an “erase discharge”.

Referring to FIG. 3, a reset period R is provided immediately before the address period EA11 of the first subfield SF1 provided foremost among the first to L-th subfields SF1 to SFL having the address periods EA111 to EAL₁₈ and EA1₂₁ to EAL₂₈, respectively, of the selective erase method, such that all of the discharge cells are initialized and set to the light emitting cell state by the reset period R. That is, all of the discharge cells are initialized and set to the light emitting cell state during the reset period R, and are set to a cell state which is capable of performing an erase discharge during the address period EAL.

Subsequently, at the first subfield SF1, the address periods EAl₁₁, to EAL₁₈ and EA1₂₁ to EAL₂₈ and sustain periods S1₁₁, to SL₁₈ and S1₂₁ to SL₂₈ are sequentially performed for the respective first to eighth sub-groups G₁₁ to G₁₈ and G₂₁ to G₂₈ of the first and second row groups G₁ and G₂. At the respective subfields SF1 to SFL of the first row group G₁, the address periods EA1₁₁ to EAL₁₈ and sustain periods S1₁₁ to SL₁₈ are subsequently performed from the first sub-group G₁₁ to the eighth sub-group G₁₈, and at the respective subfields SF1 to SFL of the second row group G₂, the address periods EA1₂₈ to EAL₂₁ and sustain periods S1₂₈ to SL₂₁ are subsequently performed from the eighth sub-group G₂₈to the first sub-group G₂₁. That is, at the k-th subfield SFk of the first row group G₁, address periods EAk₁ᵢ of i-th sub-group G₁ᵢ are performed, and then sustain periods Sk₁ᵢ of the i-th sub-group G₁ᵢ are performed (here, k is an integer in a range of 1 to L and i is an integer in a range of 1 to 8). Subsequently, address periods EAk₁₍ᵢ₊₁₎ and sustain periods Sk₁₍ᵢ₊₁₎ of (i+1)-th sub-group G₁₍ᵢ₊₁₎ are performed. At the k-th subfield SFk of the second row group G₂, address periods EAk₂₍ᵢ₊₁₎ of the (i+1)-th sub-group G₂₍ᵢ₊₁₎ are performed and then sustain periods Sk₂₍ᵢ₊₁₎ of the (i+1)-th sub-group G₂₍ᵢ₊₁₎ are performed. Subsequently, address periods EAk₂ᵢ and sustain periods Sk₂ᵢ of the i-th sub-group G₂ᵢ are performed.

In addition, at the k-th subfield SFk, the address periods EAk₂₍₈₋₍ᵢ₋₁₎₎ of the (8−(i−1))-th sub-group G₂₍₈₋₍ᵢ₋₁₎₎ of the second row group G₂are performed while the sustain periods Sk₁ᵢ of the i-th sub-group G₁ᵢ of the first row group G₁ are performed. At the k-th subfield SFk, the address periods EAk₁₍ᵢ₊₁₎ of the (i+1)-th sub-group G₁₍ᵢ₊₁₎ of the first row group G₁ are performed while the sustain periods Sk₂₍₈₋₍ᵢ₋₁₎₎ of the (8−(i−1))-th sub-group G₂₍₈₋₍ᵢ₋₁₎₎ of the second row group G₂are performed.

In FIG. 3, at the second row group G₂, the address periods EAk₂₈ to EAk₂₁ and sustain periods S₂₈ to S₂, are subsequently performed from the eighth sub-group G₂₈ to the first sub-group G₂₁. However, in contrast to FIG. 3, at the second row group G₂, the address periods EAk₂₁ to EAk₂₈ and sustain periods S1₂₁ to SL₂₈ may be subsequently performed from the first sub-group G₂₁ to the eighth sub-group G₂₈, in the same manner as in the first row group G₁. In addition, in the first and the second row groups G₁ and G₂, the address and sustain periods may be performed in a sequence different from that in FIG. 3.

Next, the respective subfields SF1 to SFL of the first row group G₁ will be described in detail. Since the address and sustain periods have substantially the same operations for the respective subfields SF1 to SFL, the operation for only the k-th subfield SFk will be described (here, k is given as an integer in the range of 1 to L).

In the k-th subfield SFk of the first row group G₁, during the address period EAk11 of the first sub-group G11, the erase discharges are generated in the discharge cells to be set as the non-light emitting cells among the light emitting cells of the first sub-group G11, and accordingly, the wall charges are erased, and during the sustain period Sk11, other light-emitting cells of the first sub-group G11 are sustain-discharged. Subsequently, during the address period EAk12 of the second sub-group G21, the erase discharges are generated in the discharge cells to be set as the non-light emitting cells among the light emitting cells of the second sub-group G12, and accordingly, the wall charges are erased, and during the sustain period Sk12, other light emitting cells of the second sub-group G12 are sustain-discharged. In addition, the light emitting cells of the first sub-group G11 are sustain-discharged.

In such a manner, the address periods EAk₁₃ to EAk₁₈ and sustain periods Sk₁₃ to Sk₁₈ are performed in other sub-groups G₁₃ to G₁₈. At this point, during the sustain periods Sk₁ᵢ of the i-th sub-group G₁ᵢ, the light emitting cells of the i-th sub-group G₁ᵢ, the first to (i−1)-th sub-groups G₁₁ to G₁₍ᵢ₋₁₎, and the (i+1)-th to eighth sub-groups G₁₍ᵢ₊₁₎ to G₁₈ are sustain-discharged. The light emitting cells of the first to (1−1)-th sub-groups G₁₁ to G₁₍ᵢ₋₁₎ have not undergone an erase discharge during the respective address periods EAk₁₁ to EAk₁₍ᵢ₋₁₎ of the k-th subfield SFk, and the light emitting cells of the (i+1)-th to eighth sub-groups G₁₍ᵢ₊₁₎ to G₁₈ have not undergone an erase discharge during the respective address period EA(k−1)₁₍ᵢ₊₁₎ to EA(k−1)₁₈ of the (k−1)-th subfield SF(k−1). In addition, the light emitting cells of the i-th sub-group G₁ᵢ have undergone a sustain discharge until the sustain period SK₍ᵢ₋₁₎ which is immediately before the address period EA3₁ᵢ of the i-th sub-group G₁ᵢ of the (k+1)-th subfield (SF(k+1)). That is, the light emitting cells of the i-th sub-group G₁ᵢ are sustain-discharged during the total of eight sustain periods.

As such, at all of the subfields SF1 to SFL, the address periods EA2₁₁ to EA2₁₈, . . . , and EAL₁₁ to EAL₁₈ and sustain periods S2₁₁ to S2₁₈, . . . , SL₁₁ to SL₁₈ are performed for the respective sub-groups G₁₁ to G₁₈. With the discharge cells operated in such a manner, the discharge cells set as the light emitting cells during the reset period R consecutively perform a sustain discharge until the discharge cells are set as the non-light emitting cells by the erase discharges at the respective subfields SF1 to SFL. When the discharge cells become non-light emitting cells as a result of the erase discharges, the discharge cells are not sustain-discharged after the corresponding subfields. At this point, the respective subfields SF1 to SFL have weight values corresponding to a sum of the lengths of the eight sustain periods of the respective subfields SF1 to SFL.

In addition, at the last subfield SFL of the first row group G₁, respective first to seventh sustain periods SA1_{12 t}o SA1₁₈ maybe additionallyperformed for the respective second to eighth sub-groups G₁₂ to G₁₈ such that the number of sustain discharges of the second to eighth sub-groups G₁₂ to G₁₈ are the same for each sub-group.

At the last subfield SFL, additional sustain periods SA₁₂ to SA₁₈ maybe formed in the respective second to eighth sub-group G₁₂ to G₁₈. In addition, in order not to generate a sustain discharge in the row group having undergone the eight sustain periods during the additional sustain periods SA₁₂ to SA₁₈, the erase periods ER₁₁ to ER₁₇ for erasing the wall discharges formed in the immediately previous sub-groups G₁₁ to G₁₇ are formed immediately before the additional sustain periods SA₁₂ to SA₁₈.

Meanwhile, the erase period ER₁₈ for erasing the wall charges of the eighth sub-group G₁₈ may be formed after the additional sustain period SA₁₈ of the eighth sub-group G₁₈. In addition, the erase period ER₁₈ of the eighth sub-group G₁₈ may not be formed because the reset period R is performed at the first subfield SF1 of the consecutive fields. In addition, the erase operation of such erase periods ER₁₁ to ER₁₈ may be sequentially performed for the respective row electrodes of the respective sub-groups as in the address period, and may be simultaneously performed for all of the row electrodes of the respective row groups.

In more detail, the wall charge formed in all of the discharge cells of the first sub-group G₁₁ are erased during the erase period ER₁₁ after the sustain period SL₁₈ of the eighth sub-group G₁₈ of the last subfield SFL of the first row group G₁ is performed. Then, during the additional sustain period SA₁₂, the light emitting cells of the second to eighth sub-groups G₁₂ to G₁₈ are sustain-discharged. Subsequently, during the erase period ER12, the wall charges formed in all discharge cells of the second sub-group G12 are erased, and then during the additional sustain period SA₁₃, the light emitting cells of the third to eighth sub-groups G₁₃ to G₁₈ are sustain-discharged. In such a manner, the additional sustain period SAL₁₈ is carried out. With such an operation, the number of sustain discharges are the same in the light emitting cells of the respective sub-groups G₁₁ to G₁₈.

Subsequently, referring to the respective subfields SF1 to SFL of the second row group G₂, the respective subfields SF1 to SFL of the second row group G₂ have substantially the same structure as the respective subfields SF1 to SFL of the first row group G₁. However, as described above, at the respective subfields SF1 to SFL of the second row group G₂, the address periods EA1₂₈ to EA1₂₁, . . . , EAL₂₈ to EAL₂₁ are subsequently performed in a sequence from the eighth sub-group G₂₈ to the first sub-group G₂₁, and also, the erase periods ER₂₁ to ER₂₈ of the last subfields SFL of the second row group G₂ are subsequently performed in a sequence from the eighth sub-group G₂₈ to the first sub-group G₂₁.

If such a driving method of the plasma display device is expressed only by the subfields, it may be given as in FIG. 4. In FIG. 4, one field includes 19 subfields SF1 to SF19. Referring to FIG. 4, the plurality of subfields SF1 to SF19 included in the one field are shifted by a predetermined interval in the respective sub-groups G₁₁ to G₁₈ and G₂₈ to G₂₁. At this point, the predetermined interval corresponds to a length of the address period (EAk₁ᵢ or EAk₂ᵢ) and one sustain period Sk₁ᵢ or Sk₂ᵢ for one sub-group G₁ᵢ or G₂ᵢ. In addition, it is assumed that the address period EAk₁ᵢ or EAk₂ᵢ of the one sub-group G₁ᵢ or G₂ᵢ has the same length as that of the one sustain period Sk₁ᵢ or Sk₂ᵢ of the one sub-group G₁ᵢ or G₂ᵢ, and the starting points of the respective subfields SF1 to SF19 of the second row group are shifted by the length of the address period EAk₁ᵢ or EAk₂ᵢ from starting points of the respective subfields SF1 to SF19 of the first row group G₁.

In such a manner, the sustain period may be performed for the row electrodes of the second row group G₁ during the address period of the row electrodes of the first row group G₂, and the sustain period may be performed for the row electrodes of the second row group G₁ during the address period of the row electrodes of the first row group G₂. That is, the length of the one subfield may be reduced because the address and sustain periods are not separated, and the sustain period may be performed during the address period.

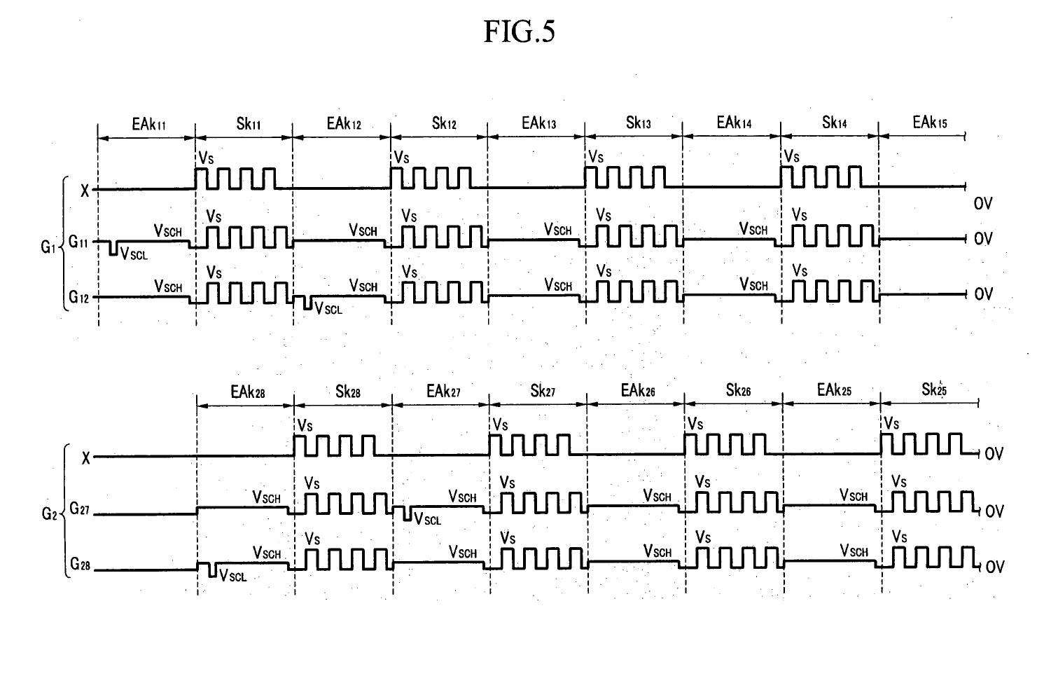

Subsequently, a driving waveform used to the driving method of the plasma display device according to the first exemplary embodiment of the present invention is described in detail with reference to FIG. 5, which shows a driving waveform of a plasma display device according to the driving method of FIG. 3.

In FIG. 5, the first and second sub-groups G₁₁ and G₁₂, respectively, of the first row group G₁ and the seventh and eighth sub-groups G₂₇ and G₂₈, respectively, of the second row group G₂ are illustrated for the one subfield SFi, and the driving waveform applied to the A electrode, and the description thereof will not be described for ease of description.

As shown in FIG. 5, a scan pulse of a voltage VSCL is sequentially applied to the plurality of Y electrodes of the first sub-group G₁₁, while a reference voltage (in FIG. 5, 0V) is applied to the X electrodes of the first sub-group G₁₁ during the address period EAi₁₁ of the first sub-group G₁₁ among the i-th subfield SFi of the first row group G₁. At this point, the address pulse (not shown) having a positive voltage is applied to the A electrodes of the cells to be selected as the non-light emitting cells from among the light emitting cells formed by the Y electrodes to which the scan pulse is applied. In addition, a voltage V_{SCH} which is greater than the voltage V_{SCL} is applied to the Y electrodes to which the scan pulse is not applied, and the reference voltage is applied to the A electrodes to which the address pulse is not applied. Then, the erase discharge is generated at the light emitting cells to which the voltages V_{SCL} of the scan pulse is applied, and accordingly, the wall charges formed on the X and Y electrodes are erased to set the non-light emitting cells.

The sustain pulse having a high-level voltage (a voltage Vs in FIG. 5) and a low-level voltage (0V in FIG. 5) is applied in inverse phases to the plurality of X electrodes of the first row group G₁ and the Y electrodes of the first to eighth sub-groups G₁₁ to G₁₈ and accordingly, the light emitting cells of the first sub-group G₁₁ are sustain-discharged. That is, 0V is applied to the X electrode while the voltage Vs is applied to the Y electrode, and 0V is applied to the Y electrode while the voltage Vs is applied to the X electrode. At this point, the cells having undergone no erase discharge during the address period EAi₁₁ are in the light emitting cell state, and accordingly, such a light emitting cell state is sustain-discharged.

Then, during the address period EAi12, the scan pulse of the voltage V_{SCL} is sequentially applied to the plurality of Y electrodes of the second sub-group G₁₂ while the reference voltage is applied to the X electrodes of the first row group G₁, and the address pulse (not shown) having a positive voltage is applied to the A electrodes of the cells to be selected as the non-light emitting cells among the light emitting cells formed by the Y electrodes to which the scan pulse is applied.

In addition, the sustain pulse is applied in inverse phases to the plurality of X electrodes of the first row group G₁ and the Y electrodes of the first and second sub-groups G₁₁ and G₁₂, respectively, during the sustain period Si12, and accordingly, the light emitting cells are sustain-discharged. In such a manner, the address periods EA1₁₃ to EA1₁₈ and the sustain periods S1₁₃ to S1₁₈ are performed for other sub-groups G₁₃ to G₁₈.

In addition, the address period EAi₂₈ of the eighth sub-group G₂₈ of the i-th subfield SFi is performed in the second row group G₂, while the sustain period Si₁₁ of the first sub-group G₁₁ is performed in the i-th subfield SFi of the first row group G₁. At the i-th subfield SFi of the second row group G₂, a scan pulse of a voltage VscL is applied to the plurality of Y electrodes of the eighth sub-group G₂₈, while a reference voltage is applied to the X electrodes of the second row group G₂, and the address pulse (not shown) having a positive voltage is applied to the A electrodes of the cells to be selected as the non-light emitting cells from among the light emitting cells formed by the Y electrodes to which the scan pulse is applied during address period EAi₂₈ of the eighth sub-group G₂₈.

In addition, the sustain pulse is applied in inverse phases to the plurality of X electrodes of the second row group G₂ and the Y electrodes of the seventh to eighth sub-groups G₂₁ and G₂₈ during the sustain period Si₂₈, and accordingly, the light emitting cells are sustain-discharged. Furthermore, the address period EAi12 of the second sub-group G₁₂ is performed at the i-th subfield SFi of the first row group G₁ while the sustain period Si₂₈ is performed at the i-th subfield SFi of the second row group G₂. In such a manner, the address periods EAi27 to EAi₂₁ and the sustain periods Sk27 to Sk₂₁ are performed for other sub-groups G₂₇ to G₂₁.

The sustain pulse of an inverse phase is applied to the plurality of X electrodes of the second row group G₂ and the Y electrodes of the first and second sub-groups G₁₁ and G₁₂ during the sustain period Sk₂₈, and accordingly, the sustain discharge is generated in the light emitting cells. In such a manner, the address periods EAi₁₃ to EAi₁₈ and the sustain periods Sk₁₃ to Sk₁₈ are performed for other sub-groups G₁₃ to G₁₈.

As such, since the priming particles formed during the sustain period are sufficiently used during the address period in that the address periods are disposed between the sustain periods of the respective sub-groups, the width of the scan pulse become shorter so as to thereby increase the speed of the scan, and the sustain period may be operated during the address period so as to thereby reduce the length of the subfield.

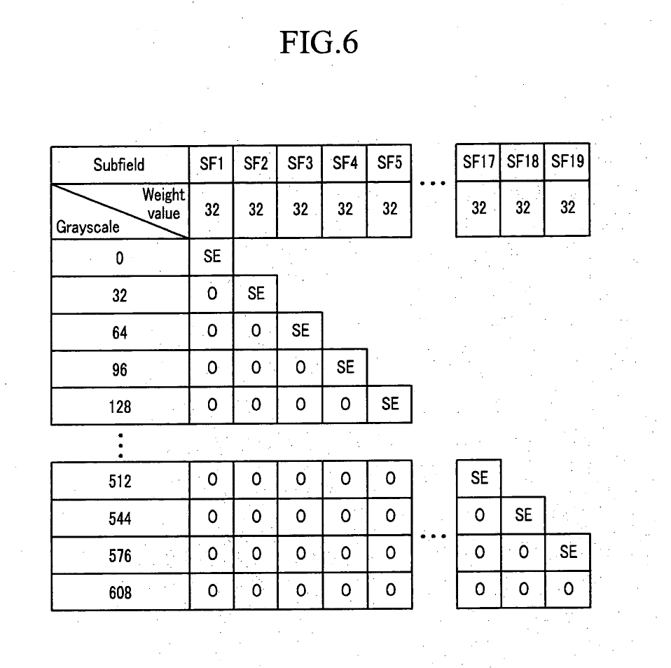

FIG. 6 shows a method for expressing a grayscale using the driving method of FIG. 3 according to a first exemplary embodiment of the present invention.

In FIG. 6, one field includes a total of 19 subfields, and the respective subfields have a weight value of 32. In addition, in FIG. 6, “SE” indicates that the erase discharge is generated in a corresponding subfield, and accordingly the light emitting cells are set as non-light emitting cells, and “O” indicates a subfield of the light emitting cell state.

As also shown in FIG. 6, when an erase discharge is generated during the address period of the first subfield SF1, and the cells accordingly become non-light emitting cells, the sustain discharge is not generated during the sustain period, and the sustain discharge is generated, even in the next subfields SF2 to SF19. Accordingly, a grayscale of 0 is expressed. Next, when an erase discharge is generated during the address period of the second subfield SF2, and accordingly the cells become non-light emitting cells, the sustain discharge is not generated from the second subfields SF2 to SF19, and thus a grayscale of 32 is expressed. When the erase discharge is not generated during the address period of the second subfield SF2, but is generated during the address period of the third subfield SF3, and accordingly the light emitting cells become non-light emitting cells, a grayscale of 64 may be expressed. That is, when the light emitting cells become non-light emitting cells as a result of the erase discharge of the K-th subfield, a grayscale of 32×(K−1) may be finally expressed because the sustain discharge is consecutively generated at the first to (K−1)-th subfield of the discharge cells of the light emitting cell state. That is, the grayscale corresponding to a multiple of 32 may be expressed among grayscales 0 to 628 (=32×19). At this point, grayscales other than multiples of 32 may be expressed using dithering. Dithering is a technology for approximately and on average expressing the grayscale to be expressed in a predetermined area by combining predetermined grayscales. Therefore, a grayscale between the grayscales 0 and 32 may be expressed using the grayscales 0 and 32 in a predetermined pixel area.

As such, according to the first exemplary embodiment of the present invention, a false contour cannot be generated because the erase discharge is generated at the corresponding subfield of the plurality of subfields SF1 to SF19, so that the grayscale is expressed by the consecutive subfields until a point in time before the discharge cells of the light emitting cell state become non-light emitting cells. In addition, at most one discharge may be required to express any grayscale because the discharge cells set to the light emitting cell state during the reset period R consecutively perform the erase discharge until they are set to non-light emitting cells by the erase discharge at the respective subfields SF1 to SF19. Therefore, power consumption according to the erase discharge may be reduced. However, the performance of a low grayscale expression may be decreased in the case where the low grayscale is not expressed by the combination of the subfields, but it is expressed by dithering. This is because the human eye can more effectively recognize a grayscale difference of a low grayscale than a grayscale difference of a high grayscale.

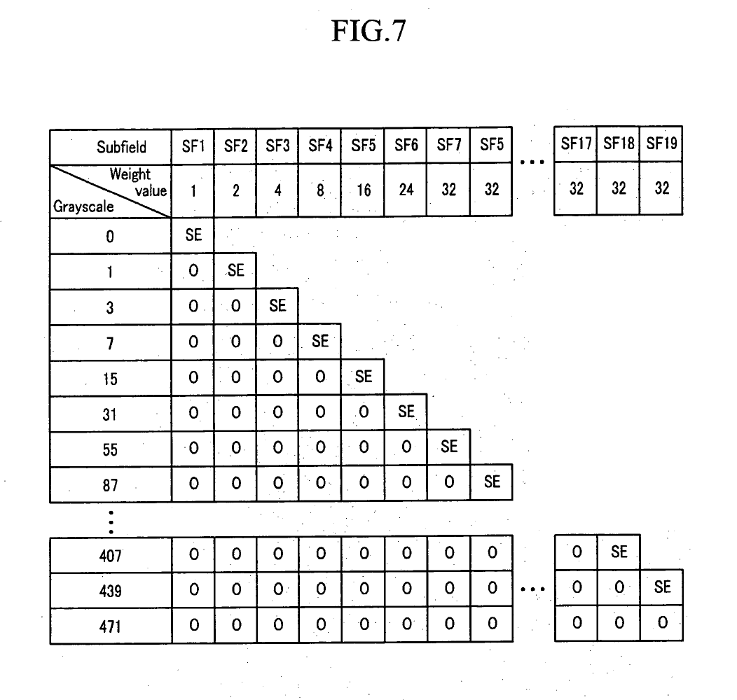

A method for enhancing the performance of the low grayscale expression may be described with reference to FIG. 7, which shows a method for expressing a grayscale using the driving method of FIG. 3 according to a second exemplary embodiment of the present invention.

As shown in FIG. 7, subfields SF1 to SFL are divided into first and second subfield groups. In addition, in order to enhance the performance of the low grayscale expression, weight values of subfields SF1, SF2, SF3, SF4, SF5, and SF6 of the first subfield group are respectively set to 1, 2, 4, 8, 16, and 24. At this point, grayscales 1, 3, 7, 15, 31, and 55, among the low grayscales expressed by dithering in FIG. 6, may be precisely expressed by the combination of the subfields SF1 to SF6 of the first subfield group. In addition, when dithering is applied for these grayscales, the performance of the grayscale expression between the grayscales 1 to 55 may be enhanced in comparison with the first exemplary embodiment.

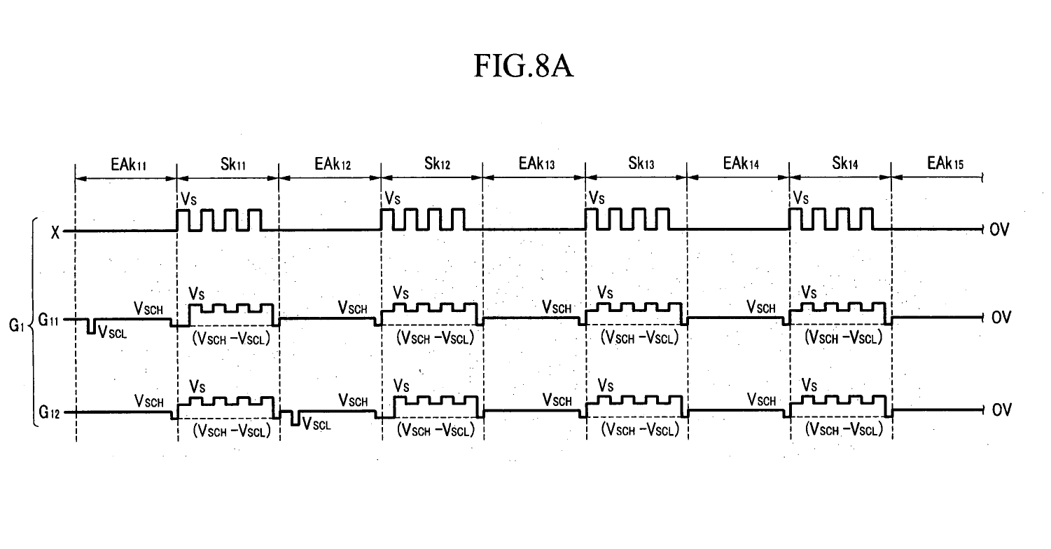

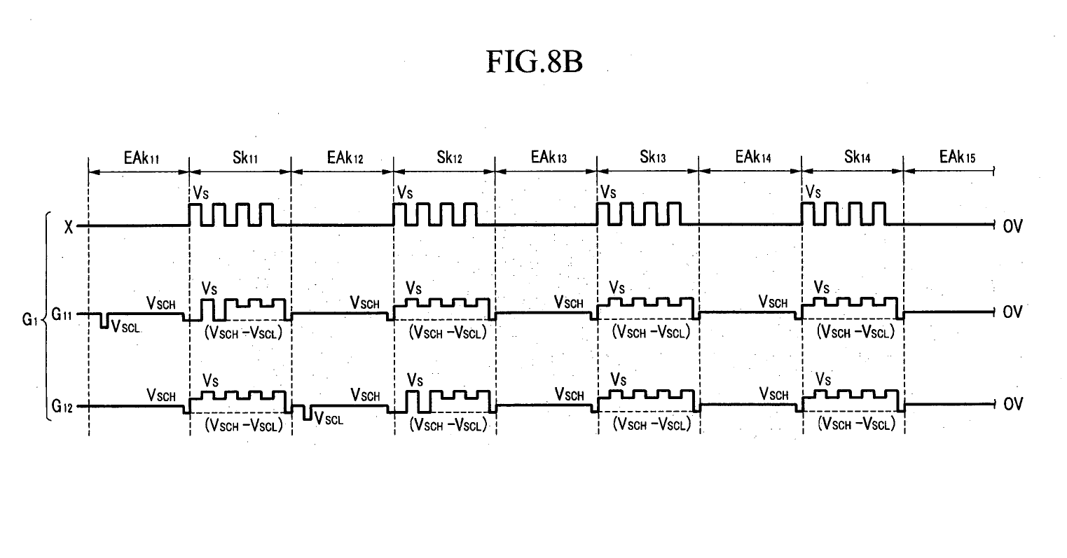

Subsequently, a method for realizing weight values of subfields SF1 to SF6 of the first group will be described with reference to FIG. 8A and FIG. 8B, which respectively show a method for realizing a weight value of subfields SF1 to SF6.

In FIG. 8A and FIG. 8B, the first and second sub-groups G₁₁ and G₁₂, respectively, of the first row group G₁ are illustrated for better understanding and ease of description.

As described above, when the first and second row groups G₁ and G₂, respectively, are divided into eight sub-groups G₁₁ to G₁₈ and G₂₁ to G₂₈, respectively, the weight values of the respective subfields SF1 to SFL correspond to the sum of the length of eight sustain periods at the respective subfields SF1 to SFL. For example, assuming that the weight value of the subfield SFk shown in FIG. 5 is given as 32, the length of the respective sustain periods Sk₁₁ to Sk₁₈ and Sk₂₁ to Sk₂₈ corresponds to the weight value 4 at the subfield SFk. In addition, it is assumed that four sustain pulses are applied to the respective X and Y electrodes during the respective sustain periods Sk₁₁ to Sk₁₈ and Sk₂₁ to Sk₂₈.

Therefore, the weight value 1 corresponds to ¼ of the length of the sustain period Sk₁₁as shown in FIG. 8A, and the voltage V_{SCH}−V_{SCL} corresponding to a difference between the voltages V_{SCH} and V_{SCL} is applied to the Y electrodes as the low level voltage of the sustain pulse after one sustain pulse is applied to the X and Y electrodes, respectively, during the sustain period Sk₁₁. In addition, during the other seven sustain periods Sk12 to Sk₁₈, the voltage V_{SCH}−V_{SCL} is applied to the Y electrode as the low level voltage of the sustain pulse. At this point, a difference Vs−VscH+VscL between the voltage Vs and the voltage VscH−VscL is set such that the sustain discharge is not generated between the X and Y electrodes. Then, the sustain discharge may not be generated between the X and Y electrodes when the voltage VscH−VscL is applied to the Y electrodes as the low level voltage of the sustain pulse. If the sustain discharge is not generated between the X and Y electrodes when the voltage Vs is applied to the X electrodes, the wall potential of the X electrodes is maintained so as to be greater than that of the Y electrodes, and accordingly, the sustain discharge is not generated again, even when the voltage Vs is applied to the electrodes Y and 0V is applied to the X electrodes. In such a manner, a subfield having the weight value of 1 may be realized.

Likewise, a weight value of 2 corresponds to half of the length of the sustain period Ski,. Accordingly, as shown in FIG. 8B, the voltage VscH−VscL is applied to the Y electrodes as the low level voltage of the sustain pulse when two sustain pulses are applied to the Y electrodes of the first sub-group G₁₁ and then the voltage Vs of the sustain pulse is applied to the X electrodes during the sustain period Sk₁₁. In addition, the voltage VscH−VscL is applied to the Y electrodes as the low level voltage of the sustain pulse even at the next sustain periods Sk₁₂ to Sk₁₈. In such a manner, a subfield having the weight value of 2 may be realized.

When each of four sustain pulses are applied to the X and Y electrodes during the sustain period Sk₁₁ and the voltage VscH−VscL is applied to the Y electrodes as the low level voltage of the sustain pulse during the next seven sustain periods Sk₁₂ to Sk₁₈, a weight value of 4 may be realized. Also, when each of four sustain pulses is applied to the X and Y electrodes during the sustain periods Sk₁₁ and Sk₁₂, and the voltage VscH−VscL is applied to the Y electrodes as the low level voltage of the sustain pulse during the sustain periods Sk₁₂ to Sk₁₈, a weight value of 8 may be realized.

Assuming that the subfield SFk shown in FIG. 5 has the weight value of 32, the sustain discharges are generated in all of the sub-groups G₂₁ to G₂₈ of the second row group G₂ when the address periods are generated in any one of the sub-groups at the first row group G₁ The sustain discharges are generated in the six sub-groups G₂₁ to G₂₆ of the sub-groups G₂₁ to G₂₈ of the second row group G₂ when the address periods are generated in any one of the sub-groups at the first row group G₁, and thus a weight value of 24 may be realized. If the sustain discharges are generated in the four sub-groups G₂₁ to G₂₄ of the sub-groups G₂₁ to G₂₈ of the second row group G₂, a weight value of 16 may be realized. The sustain discharges are generated in the two sub-groups G₂₁ and G₂₂ of the sub-groups G₂₁ to G₂₈ of the second row group G₂, so that a weight value of 8 may be realized. Likewise, a weight value of 4 may be realized when the address periods are performed in only one sub-group of the first row group G₁ and the sustain discharge is generated in only one sub-group period G₂₈ of the sub-groups G₂₁ to G₂₈, and weight values of less than 4 may be realized when the sustain discharges are generated in only a part of the sub-group period G₂₈.

It is but one example that the voltages VscH to VscL may be applied to the Y electrodes so that the sustain discharge is not generated between the electrodes X and Y in FIG. 8A and FIG. 8B. Accordingly, the Y electrodes may be floated so that the sustain discharge is not generated between the electrodes X and Y. When the Y electrodes are floated, the difference between the X and Y electrodes is reduced, and accordingly the sustain discharge is not generated in the light emitting cells because the voltage of the Y electrodes is changed depending on the voltage of the X electrodes. A high level voltage Vs is consecutively applied, or a low level voltage 0V is applied, to one of the X and Y electrodes.

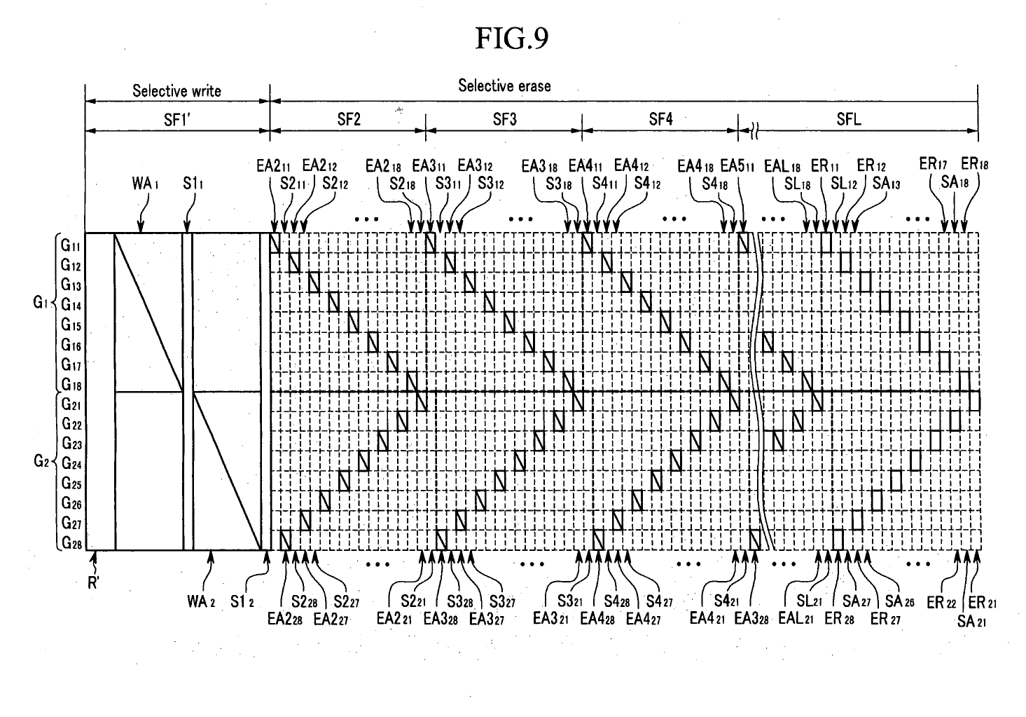

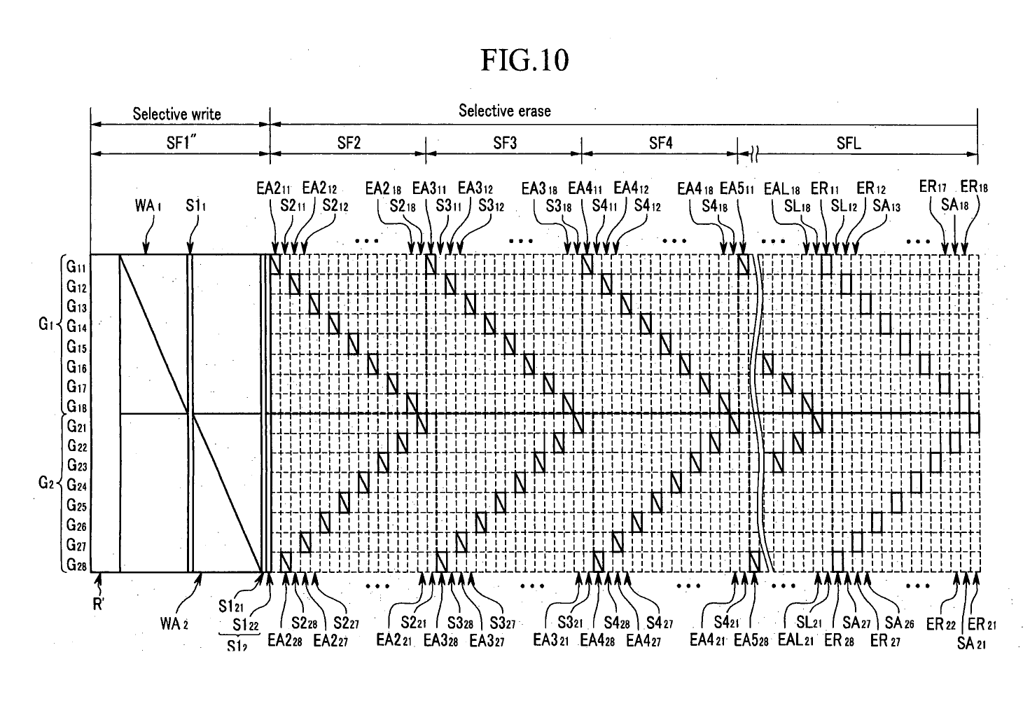

According to the driving method of the first exemplary embodiment of the present invention, the reset discharge must become a strong discharge in order that all of the discharge cells be initialized during the reset period D immediately before the address period of the first subfield SF1 and the discharge cells are set into the light emitting cell state. In this case, there is a problem in that the contrast ratio is reduced because the black screen seems to be bright. In addition, it is difficult for the wall charges to be sufficiently generated such that all of the discharge cells are set as light emitting cells only during the reset period R. A method for stably generating an erase discharge which is capable of enhancing the contrast ratio will now be described in detail with reference to FIG. 9 and FIG. 10.

FIG. 9 schematically shows a driving method of a plasma display device according to a second exemplary embodiment, and FIG. 10 schematically shows a driving method of a plasma display device according to a third exemplary embodiment.

As shown in FIG. 9, the driving method according to the second exemplary embodiment of the present invention is similar to the driving method of the first exemplary embodiment. However, unlike in the first exemplary embodiment, the selective write method of the second exemplary embodiment is used during address periods WA1₁ and WA1₂ of the first subfield SF1′. At the first subfield SF1′, the respective groups G₁ and G₂ of the plurality of row electrodes are not grouped into the sub-groups, and the light emitting cells are selected from among the discharge cells formed by the plurality of row electrodes during one address period WA1₁ or WA1₂. As such, at the subfield SF1′ having the address period WA1₁ or WA1₂ of the selective write method, a reset period R′ is formed, in which period the light emitting cells are initialized into non-light emitting cells at the reset period R′ immediately before the address period WA1₁or WA1₂. That is, the light emitting cells are initialized into non-light emitting cells at the reset period R′ immediately before the address period WA1₁ or WA1₂, in contrast to the situation wherein the charge cells are initialized into the light emitting cell state in the reset period R immediatelybefore the address periods EA1₁₁ to EAL₁₈ and EA1₂₁ to EAL₂₈ of the selective erase method in the first exemplary embodiment of the present invention.

More specifically, at the reset period R′ of the first subfield SF1′, the discharge cells of the first and second row groups G₁ and G₂ are initialized and set to the non-light emitting cell state so that a write discharge may be generated in the address period WA1₁ and WA1₂. During l1 the address period WA1₁ the write discharge is generated in the discharge cells to be set as non-light emitting cells among the discharge cells of the first row group G₁, and accordingly the wall charges are generated. Then, during the sustain period S1₁, the sustain discharge is generated in the light emitting cells of the first row group G₁. Sequentially, the wall charges formed in the light emitting cells of the first row group G₁ are erased. The light is emitted only during the sustain period S21₁ of the first sub-group G₁₁ among the light emitting cells of the first row group G₁.

Next, during the address period WA1₂, a write discharge is generated in the discharge cells to be set as light emitting cells among the discharge cells of the second row group G₂, and accordingly the wall charges are generated. Then, during the sustain period S1₂, a sustain discharge is generated in the light emitting cells of the second row group G₂, and accordingly the wall charges are erased.

As such, according to the second exemplary embodiment of the present invention, write discharges are sequentially performed for the plurality of row electrodes of the first and second row groups G₁ and G₂ during the address period WA1₁and WA1₂, and thus the light emitting cells are selected, and then the sustain periods S1₁ and S1₂ are performed to generate a sustain discharge. In such a manner, the wall charges may be sufficiently formed on the respective electrodes of the light emitting cells before the subfields SF2 to SFL having the address period of the selective erase method are performed.

Meanwhile, in order that the wall charges formed in the light emitting cells of the respective groups G₁ and G₂ after the sustain periods S1₁ and S1₂ of the respective groups G₁ and G₂ are erased at the first subfield SF1′, the pulse width of the last sustain pulse is set to be narrower than that of other sustain pulses during the sustain periods S1₁ and S1₂ of the respective groups G₁ and G₂ so that the wall charges are not formed. The wall charges formed by the sustain discharges may be erased using a waveform in which a voltage of the row electrodes is gradually changed immediately after the last sustain discharge pulse (e.g., a waveform changed in a ramp pattern).

In addition, in order that the light emitting cells be initialized into non-light emitting cells at the reset period R′ immediately before the address period WA1₁ or WA1₂ of the selective write method, a voltage may be gradually increased or gradually reduced at the reset period. That is, the voltage of the plurality of Y electrodes may be gradually increased and then gradually reduced during the reset period R′. Thus, the light emitting cells are initialized by erasing the wall charges on the discharge cells when a weak reset discharge is generated between the X and Y electrodes while the voltage of the plurality of Y electrodes is gradually increased and then gradually reduced. Accordingly, a strong discharge is not generated during the reset period R1, thereby enhancing the contrast ratio.

Likewise, for the second exemplary embodiment shown in FIG. 9, the operation of erasing the wall charges formed in the light emitting cells of the respective groups G₁ and G₂ after the sustain periods S1₁ and S1₂ of the respective groups G₁ and G₂ may not be carried out.

More specifically, as shown in FIG. 10, during the address period WA1₁ of the first subfield SF″, a write discharge is generated in the discharge cells to be set as light emitting cells among the discharge cells of the first row group G₁, and accordingly the wall charges are formed thereon. Then, during the sustain period S1₁, a sustain discharge is generated in the light emitting cells. At this point, it is set such that a minimum number of sustain discharges (for example, one or two sustain discharges) is generated during the sustain period S1₁.

Next, during the address period WA1₂ of the first subfield SF1″, a write discharge is generated in the discharge cells to be set as light emitting cells among the discharge cells of the second row group G₂, and accordingly the wall charges are generated. Then, during a partial period S1₂₁ of the sustain period S1₂, the sustain discharge is generated in the light emitting cells of the first and second row groups G₁ and G₂. In addition, during another partial period S1₂₂ of the sustain period S1₂, the sustain discharge is not generated in the light emitting cells of the first row group G₁ but rather in the second row group G₂while the sustain discharge is not generated in the light emitting cells of the first row group G₁ but rather in the light emitting cells of the second row group G₂. At this point, the same number of sustain discharges is set to be generated in the light emitting cells of the second row group G₂during another partial period S1₂₂ of the sustain period S1₂ and in the light emitting cells of the first row group G₁ during the sustain period S1₂.

When the weight value of first subfield SF1″ is not expressed by the two sustain periods S1₁ and S1₂, the additional sustain discharge may be generated in the light emitting cells of the first and second row groups G₁ and G₂, respectively, during the other partial period S1₂₂ of the sustain period S1₂.

In addition, according to the first to third exemplary embodiments of the present invention, at the last subfield SFL of one field, the erase periods ER1₁₂ to ER1₁₈ and ER1₂₂ to ER1₂₈ and the additional sustain periods SA₁₂ to SA₁₈ and SA₂₂ to SA₂₈ of the first and second row groups G₁ and G₂, respectively, may be formed or may be deleted. When the erase periods ER1₁₂ to ER1₁₈ and ER1₂₂ to ER1₂₈ and the additional sustain periods SA₁₂ to SA₁₈ and SA₂₂ to SA₂₈ are deleted, the addressing order of the respective sub-groups G₁₁ to G₁₈ and G₂₁ to G₂₈ among the respective groups G₁ and G₂over the plurality of fields are changed. Then, the same number of sustain discharges may be generated in the respective row groups.

Meanwhile, according to the fourth exemplary embodiment of the present invention, assuming 1024 row electrodes are driven under conditions that the selective erase method uses a width of the scan pulse of 0.7 μs, the eight sustain pulses are inputted during one sustain period, one sustain pulse (the pulse having high and low level voltages) is inputted for 5.6 μs, the length of the sustain period is given as 44.8 μs(=5.6 μs×8 rows), and the length of the address period is given as 44.8 μs(=0.7 μs×64 rows). Therefore, the length of the subfield is given as 716.8 μs(=44.8 μs×16). In addition, when the selective write method uses a width of a scan pulse of 1.3 μs, and a length of the reset period is given as 350 μs, the length of the address period is given as 665.6 μs(=1.3 μs×512 rows). In the case of a weight value of 1, assuming that one sustain pulse is applied during the sustain period S1₁, and 1.5 sustain pulses are applied during the sustain period S1₂, the length of the total sustain period S1₁+S1₂ is given as 14 μs(=5.6 μs×2.5). Therefore, the length of the subfield SF1 is given as 1695.2 μs(=350 μs+665.6 μs×2+l4 μs).

That is, in the case of the third exemplary embodiment, since time allocated to the subfield of the selective erase method is given as 14970.8 μs(=16666 to 1695.2) at one field, the 20(=14970.8/716.8) subfields of the selective erase method may be used at one field.

In addition, it is one example that the sustain pulse having the voltage Vs and 0V alternately in FIG. 5 is applied to the X and Y electrodes in inverse phases. Accordingly, the present invention may be applied even when the sustain pulse of other shapes is applied. That is, the present invention may be applied even when the sustain pulse alternately having the voltages—Vs and Vs X is applied to the Y electrodes while the X electrodes are biased at 0V.

As described above, according to the exemplary embodiments of the present invention, the plurality of row electrodes are divided into a first row group disposed in even-numbered rows and a second row group disposed in odd-numbered rows, and the respective groups are again divided into a plurality of sub-groups. In addition, the address periods are performed in the respective sub-groups of the respective first and second row groups at the respective subfields of the one field, and the sustain periods are performed between the address periods of respective sub-groups. The address periods are performed in the respective sub-groups of the second row group while the sustain periods are performed in the respective sub-groups of the first row group, and the sustain periods are performed in the respective sub-groups of the first row group while the address periods are performed in the respective sub-groups of the second row group. As such, since the priming particles formed during the sustain period are sufficiently used during the address period in that the address periods are 8 disposed between the sustain periods of the respective sub-groups, the width of the scan pulse becomes shorter so as to thereby increase the speed of the scan and the sustain period during the address period, thereby reducing the length of the subfield.

In addition, the address periods of the respective subfield are driven by the selective erase method, and the grayscales are expressed by the consecutive subfields until a point in time before the erase discharge is generated at the corresponding subfield, and thus a false contour cannot be generated. Furthermore, since only one erase discharge is generated to express any grayscales, power consumption is reduced.

When the first address period of the respective subfields is driven by the selective write method, sufficient wall charges may be formed, and accordingly an erase discharge may be stably generated at the next subfields driven by the selective erase method. A voltage which is gradually increased or gradually reduced is applied during the reset period of the subfield of the selective write method, and accordingly a strong discharge is not generated during the reset period, thereby enhancing the contrast ratio.

While this invention has been described in connection with what is presently considered to be practical exemplary embodiments, it is to be understood that the invention is not limited to the disclosed embodiments. On the contrary, the above description is intended to cover various modifications and equivalent arrangements included within the spirit and scope of the appended claims.

What is claimed is:

1. A method for driving a plasma display device having a plurality of row electrodes and a plurality of column electrodes, and a plurality discharge cells defined by the plurality of row electrodes and the plurality of column electrodes, wherein one field is divided into a plurality of subfields, the driving method comprising the steps of:
dividing the plurality of row electrodes into a first row group disposed in even-numbered rows and a second row group disposed in odd-numbered rows, dividing the first row group of row electrodes into a plurality of first sub-groups, and dividing the second row group of row electrodes into a plurality of second sub-groups;
at respective first subfields of a first group of subfields among a plurality of subfields, selecting non-light emitting cells among light emitting cells of one first sub-group among the plurality of first sub-groups, and sustain-discharging light emitting cells of at least one of the plurality of second sub-groups during a first period respectively corresponding to at least one second sub-group; and
at the respective first subfields, selecting the non-light emitting cells among the light emitting cells of one of the plurality of second sub-groups, and sustain-discharging the light emitting cells of at least one of the plurality of first sub-groups during a second period respectively corresponding to said at least one of the plurality of first sub-groups.

2. The driving method of claim 1, further comprising, at the respective first subfields, selecting the non-light emitting cells among the light emitting cells of another of the plurality of first sub-groups, and sustain-discharging the light emitting cells of at least one of the plurality of second sub-groups during a third period respectively corresponding to said at least one of the plurality of second sub-groups; and
at the respective first subfields, selecting the non-light emitting cells among the light emitting cells of another of the plurality of second sub-groups, and sustain-discharging the light emitting cells of said at least one of the plurality of first sub-groups during a fourth period respectively corresponding to said at least one of the plurality of first sub-groups.

3. The driving method of claim 2, further comprising, at a first subfield provided foremost of the first group of subfields, setting the plurality of discharge cells as light emitting cells before selecting non-light emitting cells.

4. The driving method of claim 2, further comprising the steps of:
at a second subfield provided foremost and consecutive to the first group of subfields, selecting the light emitting cells among a first row group of discharge cells, and sustain-discharging the selected light emitting cells; and
at the second subfield, selecting the light emitting cells among a second row group of discharge cells, and sustain discharging the selected light emitting cells.

5. The driving method of claim 4, further comprising the step of:
at the second subfield, setting the plurality of discharge cells as non-light emitting cells before selecting a first row group of light emitting cells.

6. The driving method of claim 5, wherein at the second subfield, the first row group of light emitting cells is not sustain-discharged during a first part of a period, and a second row group of light emitting cells is sustain-discharged.

7. The driving method of claim 6, wherein at the second subfield, the first row group of light emitting cells is sustain-discharged during a remaining part of the period, and the second row group of light emitting cells is also sustain-discharged.

8. The driving method of claim 1, wherein the plurality of row electrodes includes a plurality of first and second electrodes, the first row group including the plurality of first electrodes disposed in even-numbered rows and the plurality of second electrodes disposed in odd-numbered rows, the second row group including the plurality of first electrodes disposed in even-numbered rows and the plurality of second electrodes disposed in odd-numbered rows; and
wherein the plurality of first sub-groups are grouped into a plurality of first electrodes disposed in the odd-numbered rows and the plurality of second sub-groups are grouped into a plurality of first electrodes disposed in the even-numbered rows.

9. A plasma display device, comprising:
a plasma display panel (PDP) having a plurality of row electrodes for performing a display operation and a plurality of column electrodes formed in a direction crossing the row electrodes, a plurality of cells being formed at crossing parts of the plurality of row electrodes and the plurality of column electrodes;
a controller for dividing one field into a plurality of subfields, dividing the plurality of row electrodes into a first row group disposed in odd-numbered rows and a second row group disposed in even-numbered rows, dividing the first row group of row electrodes into a plurality of first sub-groups and dividing the second row group of row electrodes into a plurality of second sub-groups; and
a driver for driving the plurality of row electrodes and the plurality of column electrodes;
wherein, at respective consecutive pluralities of first subfields among the plurality of subfields, the driver selects non-light emitting cells among light emitting cells of the respective first sub-groups during a first period of the respective first sub-groups, and sustain-discharges the light emitting cells of the plurality of second sub-groups during a fourth period; and
wherein the driver selects non-light emitting cells among light emitting cells of the respective second sub-groups during a third period of the respective second sub-groups, and sustain-discharges the light emitting cells of the plurality of first sub-groups,
wherein the third period is provided between adjacent first periods.

10. The plasma display device of claim 9, wherein at a second subfield provided foremost and consecutive with respect to the plurality of first subfields, the driver selects the light emitting cells among discharge cells of the first row group, sustain-discharges the selected light emitting cells among the discharge cells of the first row group, selects the light emitting cells among discharge cells of the second row group, and sustain-discharges the selected light emitting cells among the discharge cells of the second row group.

11. The plasma display device of claim 10, wherein the driver sets the discharge cells as non-light emitting cells before it selects the light emitting cells at the second subfield.

12. The plasma display device of claim 10, wherein the second period is shorter than the first period, and the fourth period is shorter than the third period.

13. The plasma display device of claim 10, wherein the second period is substantially the same as the first period, and the fourth period is substantially the same as the third period.

14. A method for driving a plasma display device having a plurality of first and second row electrodes and a plurality of column electrodes, a plurality of discharge cells being defined by the plurality of first and second row and column electrodes, and one field being divided into a plurality of subfields, the driving method comprising the steps of:
dividing the respective pluralities of first and second row electrodes into a first row group disposed in odd-numbered rows and a second row group disposed in even-numbered rows, dividing the first row group of first row electrodes into a plurality of first sub-groups, and dividing the second row group of first row electrodes into a plurality of second sub-groups;
at at least one first subfield among the plurality of subfields, selecting light emitting cells among discharge cells of the first row group, and sustain discharging the selected light emitting cells of the first row group;
at said at least one first subfield, selecting light emitting cells among discharge cells of the second row group, and sustain-discharging the selected light emitting cells of the second row group;
at each of the plurality of second subfields among the plurality of subfields, selecting non-light emitting cells among light emitting cells of one of the plurality of first sub-groups, and sustain-discharging light emitting cells of at least one of the plurality of second sub-groups during a first period respectively corresponding to at least one second sub-group; and
at the respective second subfields, selecting the non-light emitting cells among the light emitting cells of said at least one of the plurality of second sub-groups, and sustain-discharging the light emitting cells of at least one of the plurality of first sub-groups during a second period respectively corresponding to at least one first sub-group.

15. The driving method of claim 14, further comprising, at the respective second subfields, selecting the non-light emitting cells among the light emitting cells of another first sub-group of the plurality of first sub-groups, and sustain-discharging the light emitting cells of at least one of the second sub-groups of the plurality of second sub-groups during a third period respectively corresponding to said at least one of the second sub-groups; and
at the respective second subfields, selecting the non-light emitting cells among the light emitting cells of another second sub-group of the plurality of second sub-groups, and sustain-discharging the light emitting cells of said at least one first sub-group of the plurality of first sub-groups during a fourth period respectively corresponding to said at least one first sub-group.

16. The driving method of claim 14, further comprising, at said at least one first subfield, setting the plurality of discharge cells as non-light emitting cells before selecting the light emitting cells.

17. The driving method of claim 15, wherein the setting of the plurality of discharge cells as non-light emitting cells includes gradually increasing a voltage difference between the first and second electrodes; and then gradually reducing the voltage difference between the first and second electrodes.
